(19) United States
(12) Patent Application Publication
(10) Pub. No.: US 2026/0012807 A1
(43) Pub. Date: Jan. 8, 2026

(54) SYSTEM AND METHOD FOR AZIMUTH ESTIMATION

(71) Applicant: JIO PLATFORMS LIMITED, Ahmedabad, Gujarat (IN)

(72) Inventors: Haresh B. AMBALIYA, Bhundani Gujarat (IN); Sundaresh SANKARAN, West Mumbai, Maharashtra (IN); Vikram SINGH, Mumbai, Maharashtra (IN); Makarand DERE, Panvel, Maharashtra (IN); Aayush BHATNAGAR, Navi Mumbai, Maharashtra (IN); Pradeep Kumar BHATNAGAR, Navi Mumbai, Maharashtra (IN)

(73) Assignee: JIO PLATFORMS LIMITED, Ahmedabad, Gujarat (IN)

(21) Appl. No.: 18/881,879

(22) PCT Filed: Feb. 16, 2024
(86) PCT No.: PCT/IN2024/050162

§ 371 Date: Jan. 7, 2025

(30) Foreign Application Priority Data
Feb. 24, 2023 (IN) 202321012719

(51) Int. Cl. H04W 16/18

(52) U.S. Cl. CPC H04W 16/18

(57) ABSTRACT

The present disclosure envisages a system (110) and a method (300) for azimuth planning The system (110) automates the process of azimuth estimation by providing a simple web interface where a user (102) can provide input site locations 5 pertaining to multiple site locations. The system (110) utilizes multiple site locations and automatically generates azimuth estimation and planning. The system (110) automates the entire process of ingesting huge crowdsource data, geospatial data, generating predictions and an analysis for estimating optimal sites during network planning.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to systems and methods implemented for the design of telecommunication networks. More particularly, the present disclosure relates to a system and a method for azimuth estimation and planning that streamlines an automated process for generating plurality of optimal sites for network planning.

### DEFINITION

As used in the present disclosure, the following terms are generally intended to have the meaning as set forth below, except to the extent that the context in which they are used to indicate otherwise.

The expression ‘nominal point’ used hereinafter in the specification refers to a point for the installation of a new site in terms of RF coverage and Transmission. In general, in a network with nominal coordinates (nominal point), all sites have the same cell size (the same coverage radio) and all sites are X-distant. In an aspect, the nominal point is associated with a pointing direction of an antenna. Antennas at cell sites are typically oriented to cover specific geographic areas. The nominal point may refer to the direction in which the antenna is pointed for optimal signal coverage.

These definitions are in addition to those expressed in the art.

### BACKGROUND OF THE INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admission of the prior art.

A fifth-generation cellular network provides a range of services broadly categorized into an enhanced mobile broadband (eMBB), an ultra-reliable, a low-latency communication (uRLLC), and a massive machine type communication (mMTC). Approximately 4 million cell sites radiating 4G networks have been deployed worldwide for providing broadband services. Every service type implements different design targets, hence planning and deployment for each service type is tailored for a target service. Further, 5G networks may be utilized for providing a higher bandwidth, an ultra-low latency while providing broadband services. Additionally, 5G networks may also be used for a massive internet of things (IOT) deployment.

With wide ranges of possible 5G uses cases aimed to connect millions of devices and humans using higher frequency bands, a conventional approach may be insufficient to meet the necessary requirements related to delivery of broadband services. Further, multiple iterations, planning to get an optimal site plan, a cell configuration designed for a given coverage, and a capacity criterion is complex and cumbersome to implement. Further, planning of any cellular network requires extensive paperwork and simulation that may be complex during implementation.

Conventionally, a task of network planning is performed by hundreds of engineers using various desktop-based tools, which involve huge man-hours for collecting data and pre-processing. Based on the collected data and pre-processing, a radio predictive task determines the best possible location for new proposed sites and cell level physical problems. Additional limitations and challenges pertaining to undefined planning processes, crowdsource data, and inability of scaling can be observed. Further, a siloed approach and a steep learning curve is required for network planning. Also, challenges in storing and performing spatial queries on geo datasets such as fiber, hotspots, and a point of interest (POI) is encountered after data collection.

Furthermore, the above listed complex planning mechanism affects the azimuth of the deployed antenna for coverage in an area and thereby results in network coverage area and cell overlaps and thus, there is a need in the art to provide a system and a method that can mitigate the problems associated with the prior arts.

### OBJECTS OF THE INVENTION

Some of the objects of the present disclosure, which at least one embodiment herein satisfies are listed herein below.

It is an object of the present disclosure to provide a system and a

method that provides an optimal planning output and multiple network insights for making quick business decisions regarding azimuth planning and estimation.

It is an object of the present disclosure to provide a system and a method that optimizes cellular planning to meet all requirements from a network capacity and a strategic point of view.

It is an object of the present disclosure to provide a system and a method where identified nominal points and infrastructure elements present in the area of a cone are taken into consideration for azimuth estimation.

It is an object of the present disclosure to provide a system and a method that streamlines the planning process by automating multiple components to obtain an optimal site/cell list for azimuth estimation.

It is an object of the present disclosure to optimize the network coverage by proper azimuth estimations.

It is an object of the present disclosure to configure the antennas considering the cell overlapping and other network related parameters.

### SUMMARY

The present disclosure discloses a system for estimating azimuth of an antenna serving at least one cell in a network based on density of the infrastructures present around at least one nominal point in the at least one cell. The system includes an interfacing unit, a memory, and a processor. The interfacing unit is configured to receive the at least one nominal point from an operator. The processor is configured to create a plurality of cones within a radius of the at least one nominal point. Each of the plurality of cones has a pre-determined angular separation. The memory is configured to store a predefined set of values corresponding to a number of infrastructures present in each cone of the plurality of cones. The processor is configured to receive the predefined set of values corresponding to the number of infrastructures present in each cone from the memory.

The processor is configured to select at least three cones from the plurality of cones based on the received values corresponding to the number of infrastructures present in each cone. The at least three cones include a first cone, a second cone, and a third cone. The processor is configured to determine a first center angle, a second center angle, and a third center angle corresponding to the first cone, the second cone, and the third cone. The processor is configured to determine at least three sectors (a first sector, a second sector and a third sector) based on the determined first center angle, the second center angle, and the third center angle. The processor is configured to estimate the azimuth of the antenna by calculating azimuth differences between the determined three sectors respectively.

In an embodiment, the first sector, the second sector, and the third sector include consecutive number of infrastructures in a reducing manner.

In an aspect, the processor is further configured to consider the first center angle of the first cone as an azimuth angle of the first sector. The processor is configured to calculate an azimuth difference between the azimuth angle of the first sector and the second center angle of the second cone. The processor is configured to select the second center angle of the second cone as an azimuth angle of the second sector if the calculated azimuth difference lies within a predefined range. The processor is configured to calculate an azimuth difference between the azimuth angle of the first sector and the third angle of the third cone, and the azimuth angle of the second sector and the third angle of the third cone respectively. The processor is configured to select the second center angle of the second cone as an azimuth angle of the third sector if the azimuth difference between the first sector and the second sector is more than 120 degree. The processor is configured to arrange the calculated azimuth angles of the first sector, the second sector, and the third sector in a descending order, and reassign the first sector, the second sector, and the third sector based on the descending order of azimuth angles.

In an embodiment, the system is configured to switch to a cone next to the second cone if the calculated azimuth difference between the azimuth angle of the first sector and the second angle of the second cone lies outside of the predefined range.

In an embodiment, the system is configured to switch to a new cone next to a previously switched cone until the calculated azimuth difference between the azimuth angle of the first sector and a center angle of the new cone lies in the predefined range.

In an embodiment, the plurality of cones is calculated by dividing 360 degree by the pre-determined angular separation.

In an embodiment, the pre-determined angular separation is 10 degree and the predefined angle is 65 degree.

In an embodiment, the predefined range is between 120 degree and 180 degree.

In an embodiment, the system is configured to consider standard azimuth of 0 (alpha), 120 (beta) and 240 (gamma) degree for azimuth estimation if number of infrastructures within a scanned cone is zero.

In an embodiment, each of the first sector, the second sector, and the third sector is separated by a sector separation angle constant calculated by dividing 360 degree by a number of sectors to plan.

The present disclosure discloses a method of estimating azimuth of an antenna serving at least one cell in a network based on density of the infrastructures present around at least one nominal point in the at least one cell. The method includes creating a plurality of cones within a radius of the at least one nominal point. Each of the plurality of cones has a pre-determined angular separation. The method includes receiving a predefined set of values corresponding to a number of infrastructures present in each cone of the plurality of cones from a memory. The method includes selecting at least three cones from the plurality of cones based on the received values corresponding to the number of infrastructures present in each cone. The at least three cones include a first cone, a second cone, and a third cone. The method includes determining a first center angle, a second center angle, and a third center angle corresponding to the first cone, the second cone, and the third cone. The method includes determining at least three sectors (a first sector, a second sector and a third sector) based on the determined first center angle, the second center angle, and the third center angle. The method includes estimating the azimuth of the antenna by calculating azimuth differences between the determined three sectors respectively.

In an embodiment, a step of calculating azimuth differences includes considering the first center angle of the first cone as an azimuth angle of the first sector. The method includes calculating an azimuth difference between the azimuth angle of the first sector and the second center angle of the second cone. The method includes selecting the second center angle of the second cone as an azimuth angle of the second sector if the calculated azimuth difference lies within a predefined range. The method includes calculating an azimuth difference between the azimuth angle of the first sector and the third angle of the third cone, and the azimuth angle of the second sector and the third angle of the third cone respectively. The method includes selecting the second center angle of the second cone as an azimuth angle of the third sector if the azimuth difference between the first sector and the second sector is more than 120 degree. The method includes arranging the calculated azimuth angles of the first sector, the second sector, and the third sector sectors in a descending order, and reassigning the first sector, the second sector, and the third sector based on the descending order of azimuth angles. In an embodiment, the method includes a step of switching to a cone next to the second cone if the calculated azimuth difference between the azimuth angle of the first sector and the second angle of the second cone lies outside of the predefined range.

In an embodiment, the method includes a step of switching to a new cone next to a previously switched cone until the calculated azimuth difference of the first sector and a center angle of the new cone lies in the predefined range.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an exemplary network architecture of a system for estimating azimuth of an antenna, in accordance with an embodiment of the present disclosure.

FIG. 2 illustrates an exemplary representation of the system for estimating azimuth of an antenna, in accordance with an embodiment of the present disclosure.

FIG. 3 is an exemplary flowchart illustrating a method for estimating azimuth of an antenna, in accordance with an embodiment of the present disclosure.

FIG. 4 is an exemplary computer system in which or with which the system may be implemented, in accordance with an embodiment of the present disclosure.

The foregoing shall be more apparent from the following more detailed description of the disclosure.

### LIST OF REFERENCE NUMERALS

100-Network Architecture
102-1, 102-2 . . . 102-N-Users
104-1, 104-2 . . . 104-N-User Equipments
110—System
202—One or more processor(s)
204—Memory
206—A Plurality of Interfaces
208—Processing Engine
210—Artificial Intelligence (AI) Engine
212—Database
410—External Storage Device
420—Bus
430—Main Memory
440—Read Only Memory
450—Mass Storage Device
460-Communication Port
470—Processor

### BRIEF DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein. Example embodiments of the present disclosure are described below, as illustrated in various drawings in which like reference numerals refer to the same parts throughout the different drawings.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged.

A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items. It should be noted that the terms “mobile device”, “user equipment”, “user device”, “communication device”, “device” and similar terms are used interchangeably for the purpose of describing the invention. These terms are not intended to limit the scope of the invention or imply any specific functionality or limitations on the described embodiments. The use of these terms is solely for convenience and clarity of description. The invention is not limited to any particular type of device or equipment, and it should be understood that other equivalent terms or variations thereof may be used interchangeably without departing from the scope of the invention as defined herein.

As used herein, an “electronic device”, or “portable electronic device”, or “user device” or “communication device” or “user equipment” or “device” refers to any electrical, electronic, electromechanical, and computing device. The user device is capable of receiving and/or transmitting one or parameters, performing function/s, communicating with other user devices, and transmitting data to the other user devices. The user equipment may have a processor, a display, a memory, a battery, and an input-means such as a hard keypad and/or a soft keypad. The user equipment may be capable of operating on any radio access technology including but not limited to IP-enabled communication, Zig Bee, Bluetooth, Bluetooth Low Energy, Near Field Communication, Z-Wave, Wi-Fi, Wi-Fi direct, etc. For instance, the user equipment may include, but not limited to, a mobile phone, smartphone, virtual reality (VR) devices, augmented reality (AR) devices, laptop, a general-purpose computer, desktop, personal digital assistant, tablet computer, mainframe computer, or any other device as may be obvious to a person skilled in the art for implementation of the features of the present disclosure.

Further, the user device may also comprise a “processor” or “processing unit” includes processing unit, wherein processor refers to any logic circuitry for processing instructions. The processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor is a hardware processor.

As portable electronic devices and wireless technologies continue to improve and grow in popularity, the advancing wireless technologies for data transfer are also expected to evolve and replace the older generations of technologies. In the field of wireless data communications, the dynamic advancement of various generations of cellular technology are also seen. The development, in this respect, has been incremental in the order of second generation (2G), third generation (3G), fourth generation (4G), and now fifth generation (5G), and more such generations are expected to continue in the forthcoming time.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

At present, network planning process is completely manual and undefined. Radio engineers are required to perform all the tedious tasks of data collection, post-processing, analysis, and radio prediction on their desktops. In the traditional approach, it is not possible to make use of the power of huge crowdsourced and rich geospatial datasets. Multiple iterations are required with varying inputs to arrive at the best site plan. This traditional approach is manual, tedious, and poses several challenges. The present disclosure simplifies the network planning process by automating and integrating all the necessary components. With the present disclosure, radio engineers are provided with all the inputs required for planning in less time and obtain an optimal list of sites/cells.

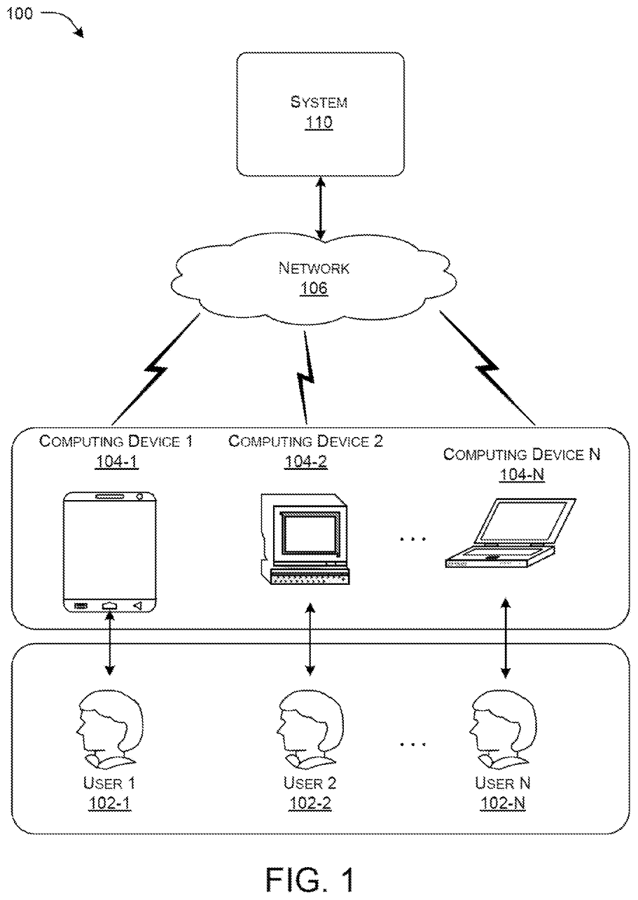

The various embodiments throughout the disclosure will be explained in more detail with reference to FIG. 1-FIG. 4.

FIG. 1 illustrates an exemplary network architecture (100) of a system (110) for estimating azimuth of an antenna serving at least one cell in a network based on density of the infrastructures present around at least one nominal point in the at least one cell, in accordance with an embodiment of the present disclosure.

As illustrated in FIG. 1, one or more user equipment (UE) (104-1, 104-2 . . . 104-N) are connected to the system (110) through a network (106). A person of ordinary skill in the art will understand that the one or more user equipments (104-1, 104-2 . . . 104-N) may be collectively referred as user equipments (UEs) (104) and individually referred as user equipment (UE) (104). One or more network operators (users) (102-1, 102-2 . . . 102-N) operate the UE (104) for providing a plurality of site locations (also known as a plurality of nominal points) to the system (110). A person of ordinary skill in the art will understand that the one or more users (102-1, 102-2 . . . 102-N) may be collectively referred as users (102) and individually referred as user (102).

The system (110) is configured to receive the plurality of nominal points from the network operator via an interfacing unit. In an example, the system (110) is configured to select at least one nominal point from the received plurality of nominal points. The interfacing unit is configured to receive the at least one nominal point from an operator. In an embodiment, the system (110) is configured to utilize the received plurality of site locations and automatically generates the azimuth estimation and planning for the plurality of site locations. Further, the system (110) generates a sector azimuth planning and a high sector azimuth planning for a telecommunications network based on the plurality of site locations provided by the network operator.

In an embodiment, the UE (104) may include, but not be limited to, a mobile, a laptop, etc. Further, the UE (104) may include one or more in-built or externally coupled accessories including, but not limited to, a visual aid device such as a camera, audio aid, microphone, or keyboard. Further, the UE (104) may include a mobile phone, smartphone, virtual reality (VR) devices, augmented reality (AR) devices, a laptop, a general-purpose computer, a desktop, a personal digital assistant, a tablet computer, and a mainframe computer. Additionally, input devices for receiving input from a user such as a touchpad, touch-enabled screen, electronic pen, and the like may be used. In an embodiment, users/customers may submit their complaints through the UE's (104) as shown in FIG. 1.

In an embodiment, the network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (106) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

The system (110), using the processor, is configured to create a plurality of cones within a radius of the at least one nominal point. Each of the plurality of cones has a pre-determined angular separation. The system (110) is configured to perform scanning of each of the plurality of cones. The system (110), via the processor, is configured to receive a number of infrastructures lies within each cone from a memory. The system (110) is configured to select at least three cones from the plurality of cones based on a calculated number of infrastructures. In an aspect, the plurality of cones is calculated by dividing 360 degree by the pre-determined angular separation. In an example, the pre-determined angular separation is 10 degree, and the predefined angle is 65 degree. In an aspect, a cone of 65 degree (cone bandwidth) is generated. The system (110) starts scanning entire area with a 10 degree separation (total 36 cones are created around each nominal point).

In an embodiment, the system (110) includes a transceiver which is configured to transmit a plurality of signals in the at least one cell. The transceiver receives a plurality of signals reflected by the number of infrastructures present in the at least one cell. Based on the received plurality of reflected signals, the system (110) is configured to calculate a number of infrastructures lie within each cone. Based on the calculated number of infrastructures, the system (110) is configured to select at select at least three cones from the plurality of cones. The at least three cones include a first cone, a second cone, and a third cone. In an example, the first cone has the maximum number of infrastructures. In an example, the first cone, the second cone, and the third cone have the number of infrastructures in a highest to lowest order. In an aspect, the system (110) is configured to consider standard azimuth of 0 (alpha), 120 (beta) and 240 (gamma) degree for azimuth estimation if number of infrastructures within a scanned cone is zero.

In an operative aspect, the system (110) is configured to analyze the radio frequency (RF) coverage of a traditional three-sector cell architecture. In an example, the system (110) determines three sectors in the cell. The system (110) is configured to perform sectorization (when cells are divided into three regions called sectors) to improve the transmission capabilities and capacity gain of a network. In an operative aspect, the system (110) is configured to determine the at least three sectors (a first sector, a second sector and a third sector) based on the determined first center angle, the second center angle, and the third center angle. In an aspect, the number of sectors is scenario dependent and is based on an operator's requirement (gain to be achieved, quality of service to be provided). In an example, the number of sectors is provided as an input to the processor. In an aspect, each of the first sector, the second sector, and the third sector is separated by a sector separation angle constant calculated by dividing 360 degree by a number of sectors to plan. For example, the sector separation angle constant is 120 degree.

In an aspect, the system (110) is configured to estimate the azimuth of the antenna by calculating azimuth differences between the determined three sectors respectively.

In an operative aspect, for calculating azimuth differences between the determined three sectors, the system (110) is configured to determine a first center angle, a second center angle, and a third center angle corresponding to the first cone, the second cone, and the third cone. In an aspect, the system (110) considers the first center angle of the first cone as an azimuth angle of a first sector. The system (110) is configured to calculate an azimuth difference between the azimuth angle of the first sector and the second center angle of the second cone. The system (110) selects the second center angle of the second cone as an azimuth angle of the second sector if the calculated azimuth difference lies between a predefined range. In an aspect, the predefined range is between 120 degree and 180 degree. In an example, the pre-determined angular separation is provided as an input to the processor. The system (110) is configured to switch to a cone next to the second cone if the calculated azimuth difference between the azimuth angle of the first sector and the second angle of the second cone lies outside a value of 120 degree and 180 degree. In an example, the system (110) is configured to switch to a new cone next to a previously switched cone (for example, the cone next to the second cone) until the calculated azimuth difference of the first sector and a center angle of the new cone lies between 120 degree and 180 degree.

In an operative aspect, the system (110) is configured calculate an azimuth difference between the azimuth angle of the first sector and the third angle of the third cone. The system (110) is configured calculate an azimuth difference between the azimuth angle of the second sector and the third angle of the third cone respectively. The system (110) selects the second center angle of the second cone as an azimuth angle of a third sector if the azimuth difference between the first sector and the second sector is more than 120 degree. The system (110) compares each azimuth angle of each sector with a reference value. In an aspect, the reference value is zero. The system (110) arranges the azimuth angles in a highest to lowest order (decreasing order), and reassign the first sector, the second sector, and the third sector based on the decreasing order of the azimuth angles. In an example, the first sector is assigned to the highest azimuth angle.

In an embodiment, once the system (110) selects the first cone having highest number of infrastructures (building, landmark), then the system (110) is configured to identify the second sector with a 120 degree from the first sector. Further, the system (110) is configured to identify the third sector with a 120 degree from the second sector. In an example, each of the first sector, the second sector, and the third sector is separated by 120 degree.

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

In an embodiment, the system (110) is configured to provide azimuth planning for rail/road/highway sector around the identified nominal point (selected from multiple site locations (i.e., nominal locations) entered by the operator via the interfacing unit. The system (110) is configured to identify a plurality of points along the rail/road having a fixed distance there between and connect each identified nominal point and identify a minimum angle and a maximum angle with the identified nominal point. Further, the system (110) is configured to an average of the identified minimum and maximum angle and consider the average for a sector. Further, for junction points, the system (110) is configured to check all traffic routes to plan sectors such that all routes get covered.

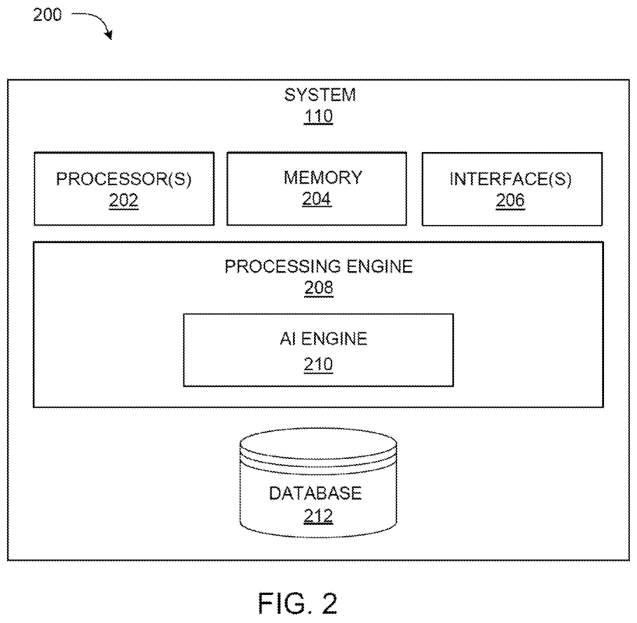

FIG. 2 illustrates an exemplary representation (200) of the system (110), in accordance with an embodiment of the present disclosure.

Referring to FIG. 2, the system (110) includes one or more processor(s) (202). The one or more processor(s) (202) may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (110). The memory (204) is configured to store one or more computer-readable instructions or routines in a non-transitory computer readable storage medium, which may be fetched and executed to create or share data packets over a network service. The memory (204) is configured to store a number of infrastructures present in the at least one cell. The memory (204) is configured to store a predefined set of values corresponding to a number of infrastructures present in each cone. The memory (204) may comprise any non-transitory storage device including, for example, volatile memory such as random-access memory (RAM), or non-volatile memory such as erasable programmable read only memory (EPROM), flash memory, and the like.

In an embodiment, the system (110) includes an interface(s) (206). The interface(s) (also known as interfacing unit) (206) may comprise a variety of interfaces, for example, interfaces for data input and output devices (I/O), storage devices, and the like. The interface(s) (206) may facilitate communication through the system (110). The interface(s) (206) may also provide a communication pathway for one or more components of the system (110). Examples of such components include, but are not limited to, processing engine(s) (208), the artificial intelligence (AI) engine (210), and a database (212).

The processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (110) may comprise the machine-readable storage medium storing the instructions and the processing resource to execute the instructions, or the machine-readable storage medium may be separate but accessible to the system (110) and the processing resource. In other examples, the processing engine(s) (208) may be implemented by electronic circuitry.

In an embodiment, the processor (202) may receive one or more inputs from the UE (104) and store the information in the database (212). The one or more inputs include a plurality of site locations provided by the operators (102).

In an embodiment, the processor (202) generates a cone/beam width (BW) for mapping the plurality of site locations. The processor (202) determines buildings and landmark (within the plurality of site locations) in the beam width/cone within a cell radius distance and identify the cone/beam width with highest count of building and landmark points. Further, the processor (202) determines an azimuth angle for the plurality of site locations and categorize the plurality of site locations into one or more sectors based on their respective azimuth angles.

In an embodiment, the processor (202) is configured to determine the plurality of nominal points on a geographical location/site location and generates a respective minimum and a maximum azimuth angle formed at the nominal points. Further, the processor (202) is configured to categorize the nominal points into various sectors based on an average of a difference between the minimum and a maximum azimuth angle formed at the nominal points.

In an embodiment, the system (110) is configured to utilize an artificial intelligence (AI) engine (208) to generate an azimuth estimation and planning for the plurality of site locations (plurality of nominal points).

In an embodiment, the AI engine (210) is configured to generate the azimuth angle for the plurality of site locations during azimuth estimation.

In an embodiment, the AI engine (210) is configured to generate the respective minimum and a maximum azimuth angle formed at the nominal locations during azimuth planning.

In an aspect, the system (110) may be implemented as a network entity with the network. The system (110) can be embedded with a beam forming source, a gNB, and similar components.

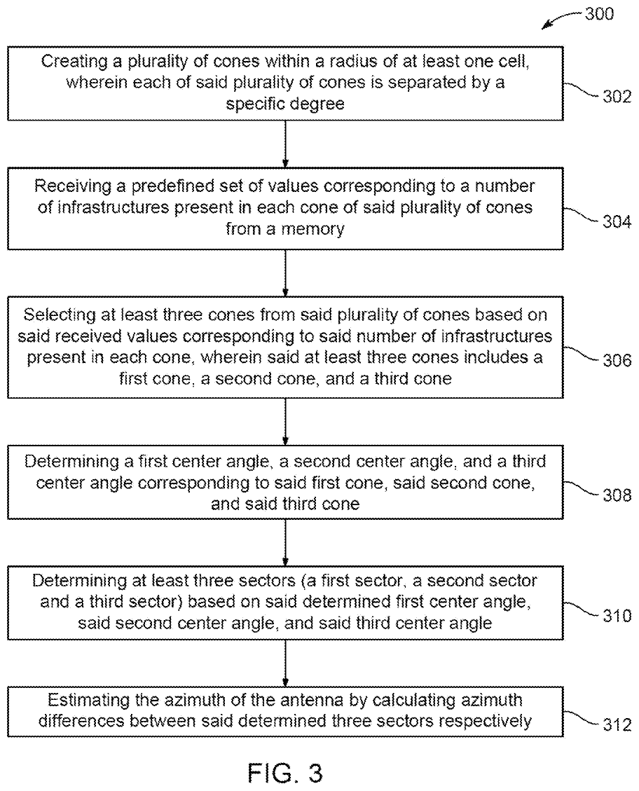

FIG. 3 is an exemplary flowchart illustrating a method (300) for estimating azimuth of an antenna serving at least one cell in a network based on density of the infrastructures present around at least one nominal point in the at least one cell, in accordance with an embodiment of the present disclosure. In an aspect, during initialization of the method (300), an operator is configured to provide the cone separation constant (pre-determined angular separation) and number of sector to plan. Further, an interfacing unit is configured to receive at least one nominal point from the operator.

Step (302) includes creating a plurality of cones within a radius of the at least one cell. Each of the plurality of cones has a pre-determined angular separation. In an example, the pre-determined angular separation is 10 degree, and the predefined angle is 65 degree. In an exemplary embodiment, the cone/beam widths may be approximated as a rectangular or an elliptical pattern for estimating an average efficiency associated with the beam widths for specific geographical locations. In an example, the method includes a step of calculating a number of cone required given as 360/cone separation constant. In an example, the method includes a step of calculating a sector separation angle constant given as 360/number of sectors to plan. In an example, 0 degree is taken as a start of the first cone. Then the first cone is drawn with the cone bandwidth constant. In an example, the cone bandwidth constant 65 degree. In an aspect, a cell radius constant is considered for each clutter. Further, the method includes a step of determining dimensions (lines, angle between line) of the cone (triangle cone). For example, lines are equal to the cell radius, and angle between line is equal to =bandwidth constant. In an example, a number of required parameters value (number of buildings, users, call drop, traffic, physical obstacles) within the cone are received from the memory.

Step (304) includes receiving a number of infrastructures lies within each cone from the memory. In an embodiment, the memory stores a number of infrastructures present in the cell and a predefined set of values corresponding to a number of infrastructures present in each cone. In an example, a transceiver is configured to transmit a plurality of signals in the at least one cell. The transceiver receives a plurality of signals reflected by the number of infrastructures present in the at least one cell. Based on the received plurality of reflected signals, the system (110) is configured to calculate the number of infrastructures lie within each cone. In an example, the step (304) may include a step of scanning of the plurality of cones.

Step (306) includes selecting at least three cones from the plurality of cones based on the received value corresponding to the number of infrastructures. The least three cones include a first cone, a second cone, and a third cone. In an example, the first cone has highest number of infrastructures. The second cone has second highest number of infrastructures. The third cone has third highest number of infrastructures. The method includes a step of incrementing cone count by 1.

Then the method includes a step of checking whether the cone count is equal to the required cone. If no, the number of required parameters value (number of buildings, users, physical obstacles) within cone are received from the memory and cone count is incremented by 1. If cone count is equal to the required cone, the method includes a step of checking “is any cone has parameter value?”. If no cone has parameter value, then the method includes a step of planning sector with separation of angle=360/Number of sector to plan. If the cone has parameter value, then identify a cone with highest parameters value as sector and azimuth of sector is considered as a center angle of identified cone (first cone). Then increase planned sector count by 1.

Step (308) includes determining a first center angle, a second center angle, and a third center angle corresponding to the first cone, the second cone, and the third cone.

Step (310) includes determining at least three sectors (a first sector, a second sector and a third sector) based on the determined first center angle, the second center angle, and the third center angle. In next step, the method includes a step of checking whether the planned sector count is equal to number sectors to plan. If yes, sort all planned sector angle from 0 to 360 degree and label them accordingly starting with 1 (shown in step 312).

If the planned sector count is not equal to number sectors to plan, the method includes a step of checking whether is any cone has parameter value?(Exclude first cone which is planned as sector).
If yes, the method includes a step of identifying a cone (for example, the second cone) with highest parameters value from remaining cones (exclude cones which planned as sectors). Further, the method includes a step of checking whether the center angle (azimuth angle) of identified sector (first sector) is greater than equal to sector separation angle constant (for example 120 degree) from all planned sectors. In an example, the method includes a step of checking an azimuth difference between the first sector azimuth and center of second identified cone. If the azimuth difference is more than 120 degree and less than 180 degree than select second cone center as azimuth for the second sector, else take next cone with 10 degree change till criteria of sector separation of the first sector and the second sector satisfy.
If yes, the method includes a step of considering center angle as planned azimuth and mark cone as planned. If no, the method includes a step of checking whether the center angle is within range of delta angle (more than 120 degree and less than 180 degree). In an example, the delta angle is defined as +or − allowed angle as compared to required sector separation constant. If the center angle is within range of delta angle, the method includes a step of checking whether consider center angle as planned azimuth and mark cone as planned (for example, second sector). If the center angle does not lie within range of delta angle, the method includes a step of selecting next cone in sequence as per angle for sector plan and increment the planned sector count by 1.

If no cone has parameter value, the method includes a step of checking whether number of sectors to plan is equal to the number of sector to plan minus sector planned counter and sort all planned sector angle from 0 to 360 degree and label them accordingly starting with 1. In next step, the method includes a step of checking whether is it possible to plan remain sectors with sector separation constant with all planned sectors or not. If yes, the method includes a step of planning remain sector with separation of sector separation constant from all planned sectors and sort all planned sector angle from 0 to 360 degree and label them accordingly starting with 1 (shown in step 312). If no, then the method includes a step of identifying largest separation within all planned sectors and planning sector at center of identified separations.

Step (312) estimating the azimuth of the antenna by calculating azimuth differences between the determined three sectors respectively. To calculate the azimuth differences between the determined three sectors, the method includes considering the first center angle of the first cone as an azimuth angle of a first sector. The method includes calculating an azimuth difference between the azimuth angle of the first sector and the second center angle of the second cone.

Step (312) includes selecting the second center angle of the second cone as an azimuth angle of a second sector if the calculated azimuth difference lies between 120 degree and 180 degree.

Step (312) includes calculating an azimuth difference between the azimuth angle of the first sector and the third angle of the third cone, and the azimuth angle of the second sector and the third angle of the third cone respectively. In an embodiment, the step (312) includes switching to a cone next to the second cone if the calculated azimuth difference between the azimuth angle of the first sector and the second angle of the second cone lies outside a value of 120 degree and 180 degree. Step (312) includes switching to a new cone next to a previously switched cone until the calculated azimuth difference of the first sector and a center angle of the new cone lies between 120 degree and 180 degree.

Step (312) further includes selecting the second center angle of the second cone as an azimuth angle of a third sector if the azimuth difference between the first sector and the second sector is more than 120 degree.

Step (312) further includes comparing each azimuth angle of each sector with a reference value and arrange the azimuth angles in a highest to lowest order (decreasing order), and reassign the first sector, the second sector, and the third sector based on the decreasing order of the azimuth angles. Step (312) further includes sorting all planned sector angle (azimuth angle of each sector) from 0 to 360 degree and label them accordingly starting with 1.

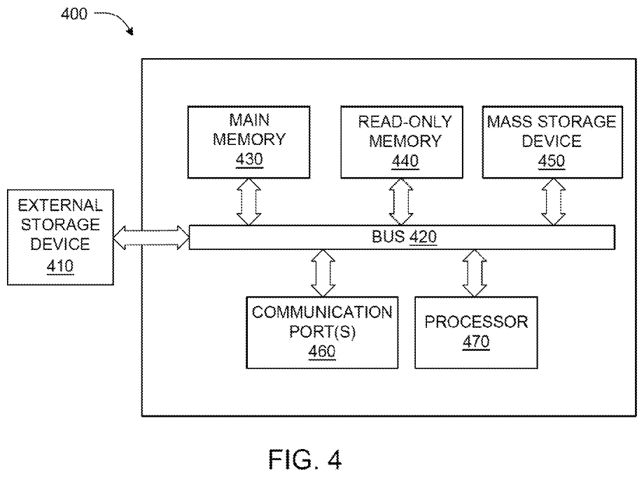

FIG. 4 is an exemplary computer system (400) in which or with which the system (110) may be implemented, in accordance with an embodiment of the present disclosure As shown in FIG. 4, the computer system (400) may include an external storage device (410), a bus (420), a main memory (430), a read only memory (440), a mass storage device (450), a communication port (460), and a processor (470). A person skilled in the art will appreciate that the system (110) may include more than one processor (470) and communication ports (460). Processor (470) may include various modules associated with embodiments of the present disclosure.

In an embodiment, the communication port (460) may be any of an RS-232 port for use with a modem-based dialup connection, a 10/100 Ethernet port, a Gigabit or 10 Gigabit port using copper or fiber, a serial port, a parallel port, or other existing or future ports. The communication port (460) may be chosen depending on a network, such a Local Area Network (LAN), Wide Area Network (WAN), or any network to which the computer system (400) connects.

In an embodiment, the memory (430) may be Random Access Memory (RAM), or any other dynamic storage device commonly known in the art. Read-only memory (440) may be any static storage device(s) e.g., but not limited to, a Programmable Read Only Memory (PROM) chips for storing static information e.g., start-up or Basic Input/Output System (BIOS) instructions for the processor (470).

In an embodiment, the mass storage (450) may be any current or future mass storage solution, which may be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g., an array of disks (e.g., SATA arrays).

In an embodiment, the bus (420) communicatively couples the processor(s) (470) with the other memory, storage, and communication blocks. The bus (420) may be, e.g., a Peripheral Component Interconnect (PCI)/PCI Extended (PCI-X) bus, Small Computer System Interface (SCSI), Universal Serial Bus (USB) or the like, for connecting expansion cards, drives and other subsystems as well as other buses, such a front side bus (FSB), which connects the processor (470) to the computer system (400).

Optionally, operator and administrative interfaces, e.g., a display, keyboard, joystick, and a cursor control device, may also be coupled to the bus (420) to support direct operator interaction with the computer system (400). Other operator and administrative interfaces may be provided through network connections connected through the communication port (460). Components described above are meant only to exemplify various possibilities. In no way should the aforementioned exemplary computer system (400) limit the scope of the present disclosure.

The present disclosure is configured to provide network planning and design of 5G networks. The system (110) can be extended to other technologies as well such as Wi-Fi, and various areas where azimuth angle calculations (such as satellite communication, navigational systems) are required. The system (110) provides an automation to azimuth angle calculation such that a network operator is able to estimate the azimuth of the antenna installed on the site in efficient manner. The system (110) automates the process of azimuth estimation by providing a simple web interface where the user can define the input requirements for any geography.

The method and system of the present disclosure may be implemented in a number of ways. For example, the methods and systems of the present disclosure may be implemented by software, hardware, firmware, or any combination of software, hardware, and firmware. The above-described order for the steps of the method is for illustration only, and the steps of the method of the present disclosure are not limited to the order specifically described above unless specifically stated otherwise. Further, in some embodiments, the present disclosure may also be embodied as programs recorded in a recording medium, the programs including machine-readable instructions for implementing the methods according to the present disclosure. Thus, the present disclosure also covers a recording medium storing a program for executing the method according to the present disclosure.

While the foregoing describes various embodiments of the present disclosure, other and further embodiments of the present disclosure may be devised without departing from the basic scope thereof. The scope of the present disclosure is determined by the claims that follow. The present disclosure is not limited to the described embodiments, versions, or examples, which are included to enable a person having ordinary skill in the art to make and use the present disclosure when combined with information and knowledge available to the person having ordinary skill in the art.

### ADVANTAGES OF THE INVENTION

The present disclosure provides a system and a method that provides an optimal planning output and multiple network insights for making quick business decisions regarding azimuth planning and estimation.

The present disclosure provides a system and a method that optimizes cellular planning to meet all requirements from a network capacity and a strategic point of view.

The present disclosure provides a system and a method where identified nominal points and infrastructure present in the area of a cone are taken into consideration for azimuth estimation.

The present disclosure provides a system and a method that streamlines the planning process by automating multiple components to obtain an optimal site/cell list for azimuth estimation.

The present disclosure facilitates optimization of the network coverage by proper azimuth estimations.

The present disclosure facilitates configuration of the antennas considering the cell overlapping and other network related parameters.

The present disclosure improvises the telecommunications network.

We claim:

1. A system (110) for estimating azimuth of an antenna serving at least one cell in a network based on density of the infrastructures present around at least one nominal point in said at least one cell, said system comprising:
an interfacing unit configured to receive said at least one nominal point from an operator; and
a processor configured to:
create a plurality of cones within a radius of said at least one nominal point, wherein each of said plurality of cones has a pre-determined angular separation;
receive a predefined set of values corresponding to a number of infrastructures present in each cone of said plurality of cones from a memory;
select at least three cones from said plurality of cones based on said received values corresponding to said number of infrastructures present in each cone, wherein said at least three cones include a first cone, a second cone, and a third cone;
determine a first center angle, a second center angle, and a third center angle corresponding to said first cone, said second cone, and said third cone;
determine at least three sectors (a first sector, a second sector and a third sector) based on said determined first center angle, said second center angle, and said third center angle; and
estimate the azimuth of the antenna by calculating azimuth differences between said determined three sectors respectively.

2. The system (110) as claimed in claim 1, wherein said first sector, said second sector, and said third sector include consecutive values corresponding to said number of infrastructures in a reducing manner.

3. The system (110) as claimed in claim 1, wherein said processor is configured to:
consider said first center angle of said first cone as an azimuth angle of said first sector;
calculate an azimuth difference between said azimuth angle of said first sector and said second center angle of said second cone;
select said second center angle of said second cone as an azimuth angle of said second sector if said calculated azimuth difference lies within a predefined range;
calculate an azimuth difference between said azimuth angle of the first sector and the third angle of said third cone, and said azimuth angle of the second sector and said third angle of said third cone respectively;
select the second center angle of said second cone as an azimuth angle of said third sector if said azimuth difference between said first sector and said second sector is more than 120 degree; and
arrange the calculated azimuth angles of the said first sector, said second sector, and said third sector in a descending order, and reassign said first sector, said second sector, and said third sector based on said descending order of azimuth angles.

4. The system (110) as claimed in claim 3, is configured to switch to a cone next to said second cone if the calculated azimuth difference between said azimuth angle of said first sector and the second angle of said second cone lies outside of said predefined range.

5. The system (110) as claimed in claim 4, is configured to switch to a new cone next to a previously switched cone until said calculated azimuth difference between said azimuth angle of said first sector and a center angle of said new cone lies in said predefined range.

6. The system (110) as claimed in claim 1, wherein said plurality of cones is calculated by dividing 360 degree by said pre-determined angular separation.

7. The system (110) as claimed in claim 1, wherein said pre-determined angular separation is 10 degree and said predefined angle is 65 degree.

8. The system (110) as claimed in claim 3, wherein said predefined range is between 120 degree and 180 degree.

9. The system (110) as claimed in claim 1, is configured to consider standard azimuth of 0 (alpha), 120 (beta) and 240 (gamma) degree for azimuth estimation if number of infrastructures within a scanned cone is zero.

10. The system (110) as claimed in claim 1, wherein each of said first sector, said second sector, and said third sector is separated by a sector separation angle constant calculated by dividing 360 degree by a number of sectors to plan.

11. A method (300) of estimating azimuth of an antenna serving at least one cell in a network based on density of the infrastructures present around at least one nominal point in said at least one cell, said method comprising:
creating a plurality of cones within a radius of said at least one nominal point, wherein each of said plurality of cones has a pre-determined angular separation;
receiving a predefined set of values corresponding to a number of infrastructures present in each cone of said plurality of cones from a memory;
selecting at least three cones from said plurality of cones based on said received values corresponding to said number of infrastructures present in each cone, wherein said at least three cones include a first cone, a second cone, and a third cone;
determining a first center angle, a second center angle, and a third center angle corresponding to said first cone, said second cone, and said third cone;
determining at least three sectors (a first sector, a second sector and a third sector) based on said determined first center angle, said second center angle, and said third center angle; and
estimating the azimuth of the antenna by calculating azimuth differences between said determined three sectors respectively.

12. The method (300) as claimed in claim 11, wherein a step of calculating azimuth differences includes:
considering said first center angle of said first cone as an azimuth angle of said first sector;
calculating an azimuth difference between said azimuth angle of the first sector and the second center angle of said second cone;
selecting said second center angle of said second cone as an azimuth angle of said second sector if said calculated azimuth difference lies within a predefined range;
calculating an azimuth difference between said azimuth angle of the first sector and the third angle of said third cone, and said azimuth angle of the second sector and the third angle of said third cone respectively;
selecting the second center angle of said second cone as an azimuth angle of said third sector if said azimuth difference between said first sector and said second sector is more than 120 degree; and
arranging the calculated azimuth angles of the said first sector, said second sector, and said third sector in a descending order, and reassigning said first sector, said second sector, and said third sector based on said descending order of azimuth angles.

13. The method (300) as claimed in claim 12, includes a step of switching to a cone next to said second cone if the calculated azimuth difference between said azimuth angle of the first sector and the second angle of said second cone lies outside of said predefined range.

14. The method (300) as claimed in claim 12, includes a step of switching to a new cone next to a previously switched cone until said calculated azimuth difference of said first sector and a center angle of said new cone lies in said predefined range.

15. A computer program product comprising a non-transitory computer-readable medium comprising instructions that, when executed by one or more processors, cause the one or more processors to execute a method (300) of estimating azimuth of an antenna serving at least one cell in a network based on density of the infrastructures present around at least one nominal point in said at least one cell, said method comprising:
creating a plurality of cones within a radius of said at least one nominal point, wherein each of said plurality of cones has a pre-determined angular separation;
receiving a predefined set of values corresponding to a number of infrastructures present in each cone of said plurality of cones from a memory;
selecting at least three cones from said plurality of cones based on said received values corresponding to said number of infrastructures present in each cone, wherein said at least three cones include a first cone, a second cone, and a third cone;
determining a first center angle, a second center angle, and a third center angle corresponding to said first cone, said second cone, and said third cone;
determining at least three sectors (a first sector, a second sector and a third sector) based on said determined first center angle, said second center angle, and said third center angle; and
estimating the azimuth of the antenna by calculating azimuth differences between said determined three sectors respectively.
